(19) United States
(12) Patent Application Publication
(10) Pub. No.: US 2007/0234761 A1
(43) Pub. Date: Oct. 11, 2007

(54) ELECTROCOAT MANUFACTURING PROCESS

(75) Inventors: CHARLES L TAZZIA, GROSSE POINTE FARMS, MI (US); PAUL L HARRIS, WEST BLOOMFIELD, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/279,263

(22) Filed: Apr. 11, 2006

(51) Int. Cl. C03B 9/41

(52) U.S. Cl. 65/163

(57) ABSTRACT

The present invention provides a method of preparing an electrocoat coating composition comprising forming an aqueous emulsion comprising a film-forming component and a volatile organic compound and removing at least a portion of the volatile organic compound by ultrafiltration.

### FIELD OF THE INVENTION

The invention relates methods for preparing coating compositions used in electrodeposition of coatings onto a conductive substrate, in particular removal of organic volatile compounds from such compositions.

### BACKGROUND OF THE INVENTION

Industrial coating of metal articles that will be used in corrosive environments may include application of one or more inorganic and organic treatments and coatings. Steel automotive vehicle bodies and parts, for instance, have an aqueous phosphate coating material applied, are rinsed with rinse water after phosphating, then have an aqueous electrodeposition (or electrocoat) coating applied, followed by multiple aqueous rinses before the electrodeposited coating is cured in an oven.

Electrodeposition coating compositions and methods are widely used in industry today. One of the advantages of electrocoat compositions and processes is that the applied coating composition forms a uniform and contiguous layer over a variety of metallic substrates regardless of shape or configuration. This is especially advantageous when the coating is applied as an anticorrosive coating onto a substrate having an irregular surface, such as a motor vehicle body. The even, continuous coating layer over all portions of the metallic substrate provides maximum anticorrosion effectiveness.

Electrocoat baths usually comprise an aqueous dispersion or emulsion (which terms are used interchangeably in this disclosure) of a principal film-forming polymer or resin (which terms are also used interchangeably in this disclosure), such as an acrylic or epoxy resin, having ionic stabilization In automotive or industrial applications for which hard electrocoat films are desired, the electrocoat compositions are formulated to be curable compositions. This is usually accomplished by including in the bath a crosslinking agent that can react with functional groups on the principal resin under appropriate conditions, such as with the application of heat, and thus cure the coating. During electrodeposition, coating material containing an ionically-charged resin having a relatively low molecular weight is deposited onto a conductive substrate by submerging the substrate in an electrocoat bath having dispersed therein the charged resin and then applying an electrical potential between the substrate and a pole of opposite charge, for example, a stainless steel electrode. The charged coating material migrates to and deposits on the conductive substrate. The coated substrate is then heated to cure the coating.

Volatile organic compounds are used as solvents and liquid media in preparation of the components used in electrocoat baths, for example in preparing the film-forming resins and crosslinking agents. Organic solutions of the electrocoat components are dispersed or emulsified in water. The clear, electrocoat coating emulsions may include one or all of the electrocoat coating film-forming components. The volatile organic compounds may then be removed by vacuum distillation at an elevated temperature, for example form at 100-120° F., with agitation or circulation. The vacuum distillation also removes a portion of the water of the emulsifying medium, complicating disposal and/or reuse of the distillate. This process also requires that the emulsions be held at the elevated temperatures for lengthy times, particularly because the removal rate of the volatile organic compounds slows as the emulsion becomes more concentrated from removal of both volatile organic compounds and water. When the vacuum distillation is complete, additional deionized water is added to the emulsion, and manufacturing of the electrocoat coating composition is continued with adding pigment and other desired additives.

The process of stripping the volatile organic compounds from the unpigmented electrocoat emulsion, however, is lengthy and costly during production of electrocoat coating compositions The vacuum distillation of volatile organic compounds from the emulsion [often referred to as “stripping”], which may be carried out in a reactor or plate evaporator, may take 25 or 30 hours, tying up equipment and increasing production costs.

It would thus be desirable to introduce an improved way of stripping electrocoat emulsions during production of electrocoat compositions.

### SUMMARY OF THE INVENTION

The present invention provides a method of manufacturing an electrocoat coating composition in which at least a portion volatile organic compound is removed from an aqueous emulsion comprising at least one film-forming component using ultrafiltration.

In particular embodiments, the invention provides a method of manufacturing an electrocoat coating composition, in which an organic solution of a resin or polymer is emulsified in water and at least a portion of the organic solvent (volatile organic liquid) is removed from the emulsion using ultrafiltration.

In an embodiment of the invention, a solution of an amine-functional resin in a volatile organic solvent is formed into an emulsion by at least partially neutralizing the resin, then the emulsion is subjected to ultrafiltration to remove at least a portion of the volatile organic solvent.

As used throughout, ranges are used as a shorthand for describing each and every value that is within the range. Any value within the range can be selected as the terminus of the range. “A” and “an” as used herein indicate “at least one” of the item is present; a plurality of such items may be present, unless specified as limited to only one. Other than in the working examples provides at the end of the detailed description, all numerical values of parameters (e.g., of quantities or conditions) in this specification, including the appended claims, are to be understood as being modified in all instances by the term “about.” “About” when applied to values indicates that the calculation or the measurement allows some slight imprecision in the value (with some approach to exactness in the value; approximately or reasonably close to the value; neatly). If, for some reason, the imprecision provided by “about” is not otherwise understood in the art with this ordinary meaning, then “about” as used herein indicates at least variations that may arise from ordinary methods of measuring such parameter's.

### DETAILED DESCRIPTION OF THE PREFERRED EMBODIMENTS

The following description of the preferred embodiment(s) is merely exemplary in nature and is in no way intended to limit the invention, its application, or its uses.

The electrocoat composition is prepared by making an aqueous emulsion that includes a principal film-forming resin and volatile organic solvent. A variety of such resins are known, including without limitation, acrylic, polyester, epoxy, and polybutadiene resins. Preferably, the principal resin is cathodic, i.e., it has salted basic or quaternary groups (e.g., ammonium, sulfonium, or phosphonium groups). In a cathodic electrocoating process, the article to be coated is the cathode. Water-dispersible resins used in the cathodic electrodeposition coating process have a cationic functional group such as primary, secondary, tertiary, and/or quarternary amine moiety as a positively chargeable hydrophilic group.

In a preferred embodiment, the resin is an epoxy resin functionalized with amine groups. Preferably, the epoxy resin is prepared from a polyglycidyl ether. Preferably, the polyglycidyl ether of is the polyglycidyl ether of bisphenol A or similar polyphenols. It may also be advantageous to extend the epoxy resin by reacting an excess of epoxide group equivalents with a modifying material, such as a polyol, a polyamine or a polycarboxylic acid, in order to improve the film properties. Preferably, the polyglycidyl ether is extended with bisphenol A. Useful epoxy resins of this kind have a weight average molecular weight, which can be determined by GPC, of from about 3000 to about 6000. Epoxy equivalent weights can range form about 200 to about 2500, and are preferably from about 500 to about 1500.

Amino groups can be incorporated by reacting the polyglycidyl ethers of the polyphenols with amine or polyamines. Typical amines and polyamines include, without limitation, dibutylamine, ethylenediamine, diethylenetriamine, triethylenetetramine, dimethylaminopropylamine, dimethylaminobutylamine, diethylaminopropylamine, diethylaminobutylamine, dipropylamine, and similar compounds, and combinations thereof. In a preferred embodiment, the epoxide groups on the epoxy resin are reacted with a compound comprising a secondary amine group and at least one latent primary amine. The latent primary amine group is preferably a ketimine group. The primary amines are regenerated when the resin is emulsified.

Quarternary ammonium groups are formed, for example, from a tertiary amine by salting it with an acid, then reacting the salting hydrogen with, e.g., a compound bearing an epoxide group to produce an ammonium group. Resins used according to the invention preferably have a primary amine equivalent weight of about 300 to about 3000, and more preferably of about 850 to about 1300.

Epoxy-modified novolacs can be used as the resin in the present invention. The epoxy-novolac resin can be capped in the same way as previously described for the epoxy resin.

Cationic polyurethanes and polyesters may also be used. Such materials may be prepared by endcapping with, for example, an aminoalcohol or, in the case of the polyurethane, the same compound comprising a saltable amine group previously described may also be useful.

Polybutadiene, polyisoprene, or other epoxy-modified rubber-based polymers can be used as the resin in the present invention. The epoxy-rubber can be capped with a compound comprising a saltable amine group.

The amino equivalent weight of the cationic resin can range from about 150 to about 5000, and preferably from about 500 to about 2000. The hydroxyl equivalent weight of the resins, if they have hydroxyl groups, is generally between about 150 and about 2000, and preferably about 200 to about 800.

In an alternative embodiment, cationic or anionic acrylic resins may be used. In the case of a cationic acrylic resin, the resin is polymerized using N,N′-dimethylaminoethyl methacrylate, tert-butylaminoethyl methacrylate, 2-vinylpyridine, 4-vinylpyridine, vinylpyrrolidine or other such amino monomers. In the case of an anionic acrylic resin, the resin is polymerized using acrylic acid, methacrylic acid, crotonic acid, maleic acid, fumaric acid, crotonic acid, isocrotonic acid, vinylacetic acid, and itaconic acid, anhydrides of these acids, or other suitable acid monomers or anhydride monomers that will generate an acid group fox salting The polymerization also includes a hydroxyl-functional monomer. Useful hydroxyl-functional ethylenically unsaturated monomers include, without limitation, hydroxyethyl methacrylate, hydroxyethyl acrylate, hydroxypropyl acrylate, hydroxypropyl methacrylate, hydroxybutyl acrylate, hydroxybutyl methacrylate, the reaction product of methacrylic acid with styrene oxide, and so on. Preferred hydroxyl monomers are methacrylic or acrylic acid esters in which the hydroxyl-bearing alcohol portion of the compound is a linear or branched hydroxy alkyl moiety having from 1 to about 8 carbon atoms. The monomer bearing the hydroxyl group and the monomer bearing the group for salting (amine for a cationic group or acid or anhydride for anionic group) may be polymerized with one or more other ethylenically unsaturated monomers. Such monomers for copolymerization are known in the art. Illustrative examples include, without limitation, alkyl esters of acrylic or methacrylic acid, e.g., methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, t-butyl acrylate, t-butyl methacrylate, amyl acrylate, amyl methacrylate, isoamyl acrylate, isoamyl methacrylate, hexyl acrylate, hexyl methacrylate, 2-ethylhexyl acrylate, decyl acrylate, decyl methacrylate, isodecyl acrylate, isodecyl methacrylate, dodecyl acrylate, dodecyl methacrylate, cyclohexyl acrylate, cyclohexyl methacrylate, substituted cyclohexyl acrylates and methacrylates, 3,5,5-trimethylhexyl acrylate, 3,5,5-trimethylhexyl methacrylate, the corresponding esters of maleic, fumaric, crotonic, isocrotonic, vinylacetic, and itaconic acids, and the like; and vinyl monomers such as styrene, t-butyl styrene, alpha-methyl styrene, vinyl toluene and the like. Other useful polymerizable co-monomers include, for example, alkoxyethyl acrylates and methacrylates, acryloxy acrylates and methacrylates, and compounds such as acrylonitrile, methacrylonitrile, acrolein, and methacrolein. Combinations of these are usually employed.

Acrylic polymers may be made cathodic by incorporation of amino-containing monomers, such as acrylamide, methacrylamide, dimethyl amino ethyl methacrylate or t-butyl amino ethyl methacrylate. Alternatively, epoxy groups may be incorporated by including an epoxy-functional monomer in the polymerization reaction. Such epoxy-functional acrylic polymers may be made cathodic by reaction of the epoxy groups with amines according to the methods previously described for the epoxy resins. The molecular weight of a typical acrylic resin is usually in the range from about 2000 to about 50,000, and preferably from about 3000 to about 15,000.

The resin is formed in organic medium, e.g., as a solution in volatile organic liquid (referred to as organic solvent). The organic solvent may be one or more solvents suitable for dissolving the resin. Typically, the resin is prepared in the solvent by polymerization. Nonlimiting examples of suitable solvents include aromatic solvents such as toluene, xylene, ketones such as methyl ethyl ketone, methyl propyl ketone, methyl isobutyl ketone, esters such as butyl acetate, hexyl acetate, as well as higher-boiling cosolvents that are desirably retained in the emulsion. The organic solvents may be used singly or in combination.

In general, the resin solution may have from about 10% to about 90% by weight organic solvent, typically from about 20% to about 50% by weight organic solvent.

The resin solution is emulsified in water in the presence of a salting compound. When the resin has basic groups, such as amine groups, the resin is salted with an acid; when the resin has acid groups, the resin is salted with a base. Usually, the principal resin and the crosslinking agent are blended together before the resins are dispersed in the water. In a preferred embodiment, the resin groups are amine groups and are salted with an acid such as phosphoric acid, propionic acid, acetic acid, lactic acid, or citric acid. The salting acid may be blended with the resin or resins, mixed with the water, or both, before the resins are added to the water. The acid is used in an amount sufficient to neutralize enough of the amine groups of the principal resin to impart water-dispersibility to the resin. The resin may be fully neutralized; however, partial neutralization is usually sufficient to impart the required water-dispersibility. By “partial neutralization” we mean that at least one, but less than all, of the saltable groups on the resin are neutralized By saying that the resin is at least partially neutralized, we mean that at least one of the saltable groups on the resin is neutralized, and up to all of such groups may be neutralized. The degree of neutralization that is required to afford the requisite water-dispersibility for a particular resin will depend upon its chemical composition, molecular weight, and other such factors and can readily be determined by one of ordinary skill in the art through straightforward experimentation. Quarternary groups need not be neutralized.

Similarly, the acid groups of an anionic resin are salted with an amine such as dimethylethanolamine or triethylamine. Again, the salting agent (in this case, an amine) may be blended with the resins, mixed with the water, or both, before the resins are added to the water. The resin is at least partially neutralized, but may be fully neutralized. At least enough acid groups are salted with the amine to impart water-dispersibility to the resin.

As mentioned, the saltable resin (principal resin) may be combined with a crosslinking agent before being dispersed in water. Crosslinking agents suitable for principle resins having particular functionalities are known in the art, and may be used singly or in combination. Of particular note are blocked polyisocyanates and aminoplast resins. The crosslinking agents may also be in organic solution or contain volatile organic compounds.

Other materials may also be combined with the principal resin before it is dispersed. Nonlimiting examples include plasticizers, cosolvents, surfactants, and typical electrocoat additives, which may also or alternatively be added after emulsification, as described below

In the method of manufacturing an electrocoat coating composition, a volatile organic compound is removed from the aqueous emulsion. The process uses cross flow filtration. The ultrafiltration membrane comprises, at least on its surface, a material that resists wetting by water. Nonlimiting examples of materials that resist wetting by water include polysiloxane such as polydimethylsiloxane and polyphenylsiloxane, polytetrafluoro ethylene, as well as copolymers, graft copolymers, and polymer blends of these. One suitable membrane comprises a polyurethane-polysiloxane, such as is described in Cheon et al., Removal of volatile organic compounds from water using PU/PDMA-PTFE composite membranes by vapor permeation separation process, Memburein (2005), 15(1), 44-51 (publ. Membrane Society of Korea). The resin emulsion is circulating through a membrane filtration cell, removing volatile organic solvent. Some water may also be removed with the volatile organic material. The emulsion is concentrated by the removal of the organic solvent and water (if removed). Additional water can be combined with the ultrafiltered emulsion, and the emulsion may be recirculated through the membrane as many times as desired. The amount of volatile organic solvent remaining in the emulsion after each ultrafiltration pass may be determined, for example, by gas chromatography or liquid chromatography

The permeate of water and organic solvent may be circulated through a reverse osmosis membrane to separate purified water, which can then be re-used in the emulsification process and organic solvent, which can then be re-used in the resin polymerization process.

Following ultrafiltration, manufacture of the electrocoat coating composition is continued by adding further desired materials such as coalescing aids, pigments, antifoaming aids, and other additives.

Nonlimiting examples of pigments that may be included in the composition are titanium dioxide, ferric oxide, carbon black, aluminum silicate, precipitated barium sulfate, aluminum phosphomolybdate, strontium chromate, basic lead silicate or lead chromate. The pigments may be dispersed using a grind resin or, preferably, a pigment dispersant. The pigment-to-resin weight ratio in the electrocoat bath can be important and should be preferably less than 50:100, more preferably less than 40:100, and usually about 10 to 30:100. Higher pigment-to-resin solids weight ratios have been found to adversely affect coalescence and flow. Usually, the pigment is 10-40 percent by weight of the nonvolatile material in the bath. Preferably, the pigment is 15 to 30 percent by weight of the nonvolatile material in the bath. Any of the pigments and fillers generally used in electrocoat primers may be included. Extenders such as clay and anti-corrosion pigments are commonly included.

Nonlimiting examples of coalescing solvents include alcohols, polyols and ketones. Specific coalescing solvents include monobutyl and monohexyl ethers of ethylene glycol, and phenyl ether of propylene glycol, monoalkyl ethers of ethylene glycol such as the monomethyl, monoethyl, monopropyl, and monobutyl ethers of ethylene glycol; dialkyl ethers of ethylene glycol such as ethylene glycol dimethyl ether; or diacetone alcohol. The amount of coalescing solvent is not critical and is generally between about 0 to 15 percent by weight, preferably about 0.5 to 5 percent by weight based on total weight of the resin solids.

Nonlimiting examples of other materials that may be added are dyes, flow control agents, plasticizers, catalysts, wetting agents, surfactants, UV absorbers, HALS compounds, antioxidants, defoamers and so forth. Examples of surfactants and wetting agents include alkyl imidazolines such as those available from Ciba-Geigy Industrial Chemicals as AMINE C® acetylenic alcohols such as those available from Air Products and Chemicals under the tradename SURFYNOL® Surfactants and wetting agents, when present, typically amount to up to 2 percent by weight resin solids. Plasticizers are optionally included to promote flow or modify plating properties Examples are high boiling water immiscible materials such as ethylene or propylene oxide adducts of nonyl phenols or bisphenol A. Plasticizers can be used at levels of up to 15 percent by weight resin solids

Curing catalysts such as tin catalysts can be added. Nonlimiting examples are tin and bismuth compounds including dibutyltin dilaurate, dibutyltin oxide, and bismuth octoate. When used, catalysts are typically present in amounts of about 0.05 to 2 percent by weight tin based on weight of total resin solids.

The electrocoat emulsion is formed after ultrafiltration into an electrocoat coating composition. The coating composition is electrodeposited onto a substrate and then cured to form a coated article. The electrodeposition of the coating composition may be carried out by any of a number of processes known to those skilled in the art. The electrocoat coating composition may be applied on any conductive substrate, such as steel, copper, aluminum, or other metals or metal alloys, preferably to a dry film thickness of 10 to 35 μm. The article coated with the composition may be a metallic automotive part or body. After application, the coated article is removed from the bath and rinsed with deionized water. The coating maybe cured under appropriate conditions, for example by baking at from about 275° F. to about 375° F. for between about 15 and about 60 minutes.

Following electrodeposition, the applied coating is usually cured before other coatings, if used, are applied. When the electrocoat layer is used as a primer in automotive applications, one or more additional coating layers, such as a primer-surfacer, color coat, and, optionally, a clearcoat layer, may be applied over the electrocoat layer. The color coat may be a topcoat enamel. In the automotive industry, the color coat is often a basecoat that is overcoated with a clearcoat layer. The primer surfacer and the topcoat enamel or basecoat and clearcoat composite topcoat may be ether waterborne or solventborne. The coatings can be formulated and applied in a number of different ways known in the art. For example, the resin used can be an acrylic, a polyurethane, or a polyester. Typical topcoat formulations are described in U.S. Pat. Nos. 4,791,168, 4,414,357, 4,546,046, 5,373,069, and 5,474,811. The coatings can be cured by any of the known mechanisms and curing agents, such as a melamine or blocked isocyanate.

The description of the invention is merely exemplary in nature and, thus, variations that do not depart from the gist of the invention are intended to be within the scope of the invention Such variations are not to be regarded as a departure from the spirit and scope of the invention.

What is claimed is:

1. A method of preparing an electrocoat coating composition, comprising
forming an aqueous emulsion comprising a film-forming component and a volatile organic compound and
removing at least a portion of the volatile organic compound by ultrafiltration

2. A method of preparing an electrocoat coating composition, comprising
forming an organic solution of a resin or polymer in organic solvent;
emulsifying the organic solution in water; and
removing at least a portion of the organic solvent by ultrafiltration.

3. A method of preparing an electrocoat coating composition according to claim 2, wherein the resin or polymer is at least partially neutralized.

4. A method of preparing an electrocoat coating composition according to claim 2, wherein the resin or polymer has basic groups that are at least partially neutralized with an acid or quaternary groups.

5. A method of preparing an electrocoat coating composition according to claim 2, wherein the resin or polymer has anionic groups that are at least partially neutralized with an amine.

6. A method of preparing an electrocoat coating composition according to claim 2, wherein a pigment is added following the ultrafiltration step.

7. A method of preparing an electrocoat coating composition according to claim 2, wherein the organic solution comprises a crosslinking agent.

8. A method of preparing an electrocoat coating composition according to claim 2, wherein the ultrafiltration employs an ultrafiltration membrane having a surface material that resists wetting by water.

9. A method of preparing an electrocoat coating composition according to claim 2, wherein the ultrafiltration employs an ultrafiltration membrane comprising at least one of polysiloxane and poly(tetrafluoro ethylene) polymers,

10. A method of preparing an electrocoat coating composition according to claim 9, wherein the ultrafiltration membrane comprises a surface comprising a polyurethane-polysiloxane material.

11. A method of preparing an electrocoat coating composition according to claim 2, wherein a component is separated from ultrafiltration permeate and re-used.

12. A method of preparing an electrocoat coating composition according to claim 1, wherein the film-forming component comprises a member selected from the group consisting of epoxy resins and acrylic resins.
